(19) United States
(12) Patent Application Publication
(10) Pub. No.: US 2014/0191610 A1
(43) Pub. Date: Jul. 10, 2014

(54) COIL WIRE FOR ROTATING ELECTRIC MACHINE AND COIL BODY

(71) Applicant: Ayako HASEGAWA, Nagoya-shi (JP)

(72) Inventor: Ayako HASEGAWA, Nagoya-shi (JP)

(73) Assignee: TOYOTA JIDOSHA KABUSHIKI KAISHA, Toyota-shi (JP)

(21) Appl. No.: 14/148,973

(22) Filed: Jan. 7, 2014

(30) Foreign Application Priority Data
Jan. 10, 2013 (JP) 2013-002344

(51) Int. Cl. H02K 3/12

(52) U.S. Cl. CPC H02K 3/12
USPC 310/208

(57) ABSTRACT

A coil wire for a rotating electric machine includes: an element wire assembly formed by bundling a plurality of element wires, the plurality of element wires being coated so as to be insulated from each other; and a coating member having conductivity, the coating member coating a periphery of the element wire assembly, the coating member being positioned in a slot of a stator of the rotating electric machine and being obliquely wound with respect to a longitudinal direction of the coil wire, and the coating member being formed with a plurality of conductive belts electrically insulated from each other.

### INCORPORATION BY REFERENCE

The disclosure of Japanese Patent Application No. 2013-002344 filed on Jan. 10, 2013 including the specification, drawings and abstract is incorporated herein by reference in its entirety.

### BACKGROUND OF THE INVENTION

1. Field of the Invention

The present invention relates to a coil wire for a rotating electric machine in which a coating member is coated around an element wire assembly formed by bundling a plurality of element wires and a coil body formed therewith.

2. Description of Related Art

For example, WO 2012/049775 discloses a conventional wire for a motor formed by helically winding a belt around an outer peripheral surface of assembled wires formed by bundling a plurality of wires. WO 2012/049775 discloses that the belt used for the wire for a motor is made of metal and the electric resistance value thereof is the electric resistance value of the wire or higher. WO 2012/049775 further discloses that durability during a bending process for forming the wire for a motor into a coil is thereby enhanced, the plurality of wires are prevented from separation and kept bundled, and generation of eddy current in the coil can be reduced.

When the wire that has a coating member formed by helically winding the conductive belt is wound around a motor stator as the coil as the wire for a motor disclosed in WO 2012/049775, the coating member is split in a wire section positioned in a slot, thereby providing an advantage that generation of eddy current and circulating current can be hindered and a loss can be reduced.

### SUMMARY OF THE INVENTION

However, when the single belt is helically wound around the wire section positioned in the slot through its entire length in the longitudinal direction, a total length of the belt increases, this increase results in a large resistive loss due to elongation of a path through which current flows, and a reduction in the loss caused by eddy current and circulating current may be canceled out.

The present invention provides a coil wire for a rotating electric machine and a coil body that can reduce a loss caused by circulating current due to eddy current and at the same time reduce a resistive loss in a coating member in a section in a slot.

A coil wire for a rotating electric machine in accordance with a first aspect of the present invention includes: an element wire assembly formed by bundling plurality of element wires, the plurality of element wires being coated so as to be insulated from each other; and a coating member having conductivity, the coating member coating a periphery of the element wire assembly, the coating member being positioned in a slot of a stator of the rotating electric machine and being obliquely wound with respect to a longitudinal direction of the coil wire, and the coating member being formed with a plurality of conductive belts electrically insulated from each other.

In the coil wire for a rotating electric machine in accordance with the first aspect of the present invention, the plurality of belts may be wound in parallel via an insulating member disposed between each other.

In the coil wire for a rotating electric machine in accordance with the first aspect of the present invention, the plurality of belts may be wound in parallel at an interval from each other.

Further, in the coil wire for a rotating electric machine in accordance with the first aspect of the present invention, the coil wire may be a generally U-shaped conductor segment that has two legs and a connection section connecting one ends of the legs together, the connection section and distal end sections of the legs of the conductor segment may constitute coil end sections, and an intermediate section of the leg that is positioned in the slot may form a slot-surrounded section.

A coil body for a rotating electric machine in accordance with a second aspect of the present invention includes the coil wire for a rotating electric machine in any one of above configurations, the coil wire being formed in a coil shape so as to be wound around a tooth of a stator of the rotating electric machine.

The coil wire for a rotating electric machine and the coil body in accordance with the aspects of the present invention can reduce the loss caused by circulating current due to eddy current and at the same time reduce the resistive loss in the coating member in the section in the slot.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a coil wire which is one embodiment of the present invention;

FIG. 2 illustrates a state where the coil wire of FIG. 1 is formed in a generally U-shaped conductor segment and put on a stator;

FIG. 3 is a perspective view of a slot-surrounded section of the coil wire and a development view of a coating member in the slot-surrounded section of the coil wire;

FIG. 4 is a plan view of the conductor segment; and

FIG. 5 is a perspective view which illustrates a state where the conductor segments are welded to each other.

### DETAILED DESCRIPTION OF EMBODIMENTS

Embodiments in accordance with the present invention will be described hereinafter in detail with reference to the attached drawings. In the description, specific shapes, materials, values, directions, and so forth are examples for easy understanding of the present invention and can be appropriately changed according to uses, purposes, specifications, and the like. Further, when the description below includes a plurality of embodiments, modifications, and the like, it is presupposed that those are used in appropriate combinations.

Further, the description below is made with a rectangular wire having a quadrangular cross section as an example of a coil wire for a rotating electric machine (hereinafter, appropriately referred to as simply “coil wire”). However, the present invention is not limited to this but can widely be applied to wires having a cross section in another polygonal shape, a circular shape, and so forth.

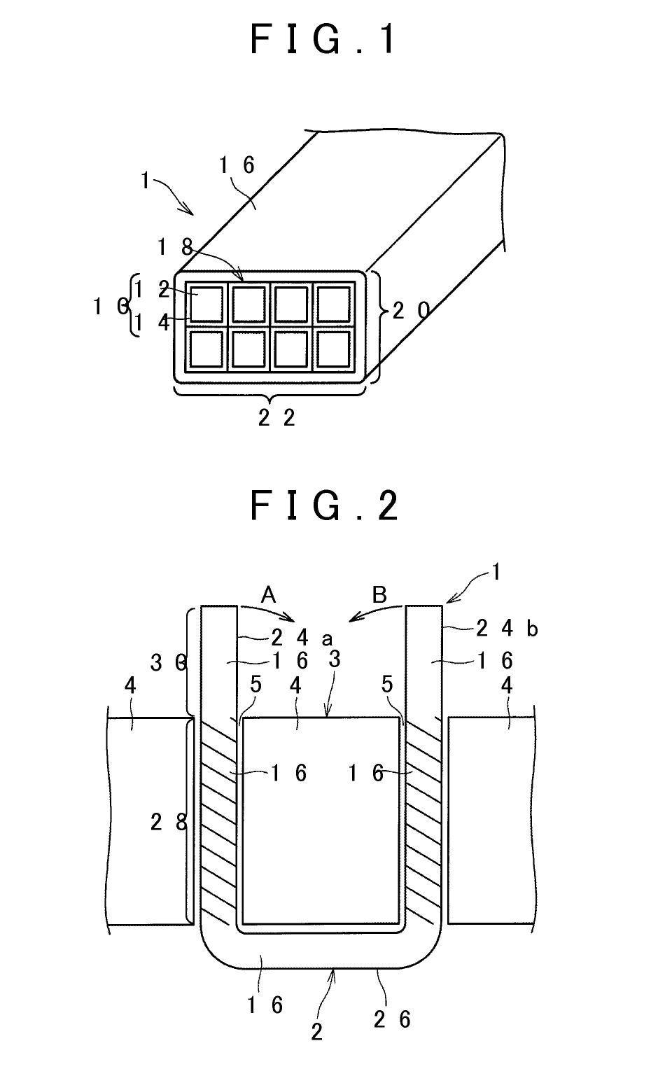

FIG. 1 is a perspective view showing a coil wire 1 that is one embodiment of the present invention. As shown in the figure, the coil wire 1 includes a plurality of element wires 10 and a coating member 16.

An insulating film 14 is provided on an outer peripheral surface of a core wire 12 in the element wire 10. The core wire 12 is a conductor and is formed in a linear shape with conductive metal such as copper, aluminum, silver, gold, or an alloy thereof. The insulating film 14 is made of an insulating material such as an enamel resin or a metal oxide.

As shown in FIG. 1, the coil wire 1 is formed by coating the coating member 16 around an outer peripheral surface of an element wire assembly 18 formed by bundling the plurality of element wires 10. The description is made with an example where the element wire assembly 18 is formed by arranging the vertical two and horizontal four, that is, eight element wires 10 as a total in the coil wire 1 in this embodiment; however, the present invention is not limited to this, but the number of the element wires can arbitrarily be changed. Further, in this embodiment, the cross section of the coil wire 1 is formed in a rectangular or oblong shape formed with short sides 20 and long sides 22.

The coating member 16 is formed by winding a plurality of conductive metal belts around the element wire assembly 18. Specifically, the coating member 16 is formed with the belts made of metal such as copper, aluminum, iron, or an alloy thereof. The coating member 16 is wound as described below and thereby has a function for binding the plurality of element wires 10 and preventing separation thereof.

FIG. 2 illustrates a state where the coil wire 1 of FIG. 1 is formed in a generally U-shaped conductor segment 2 and put on a motor stator 3. FIG. 2 shows a section of the motor stator 3 in a tubular shape in a plan view as seen from the inner peripheral side and shows teeth 4 having a rectangular end surface and a slot 5 formed between the teeth 4.

As shown in FIG. 2, in this embodiment, the coil wire 1 is formed as the conductor segment 2 formed in a general U-shape and put on the motor stator 3. The conductor segment 2 has two legs 24a, 24b in parallel with each other and a connection section 26 connected to one ends (lower ends in FIG. 2) of the legs 24a, 24b. The conductor segment 2 can be formed by a bending process of the coil wire 1 that is cut in a prescribed length.

Each of the legs 24a, 24b of the conductor segment 2 includes a slot-surrounded section (intermediate section) 28 and a distal end section 30. The slot-surrounded section 28 serves as a section that is disposed inside the slot 5 when the two legs 24a, 24b of the conductor segment 2 are inserted in the slot 5 of the motor stator 3. Meanwhile, the distal end section 30 serves as a section that protrudes outside in the axial direction (the vertical direction in FIG. 2) from the slot 5 of the motor stator 3 when the two legs 24a, 24b of the conductor segment 2 are inserted in the slot 5 of the motor stator 3 and constitutes a coil end section when the coil is formed. The connection section 26 of the conductor segment 2 also serves as a section that is disposed outside the slot 5 of the motor stator 3 on the other side in the axial direction and constitutes the coil end section when the coil is formed.

The distal end section 30 of the one leg 24a of the conductor segment 2 is bent in the direction of arrow A, and the other leg 24b is bent in the direction of arrow B. That is, the distal end sections 30 of the two legs 24a, 24b are bent in the direction to approach each other. The distal end section 30 of the one leg 24a is, for example, inserted in the slot 5 and connected by welding or the like to the distal end section of the other bent leg of the yet other conductor segment (not shown) that is arranged on a radial inside (the front side in the perpendicular direction to the page of FIG. 2). Further, the distal end section 30 of the other leg 24b is, for example, inserted in the slot 5 and connected by welding or the like to the distal end section of the other bent leg of the still other conductor segment (not shown) that is arranged on a radial outside (the deeper side in the perpendicular direction to the page of FIG. 2).

The plurality of conductor segment 2 are connected together as described above, and the coil (coil body) is formed around the tooth 4 through the slot 5 by distributed winding. In such a coil, the coil wire 1 is wound such that both side surfaces on the short sides 20 of the coil wire 1 serve as side surfaces on inner peripheral side and outer peripheral side of the coil. Such a coil is also referred to as “edgewise coil”.

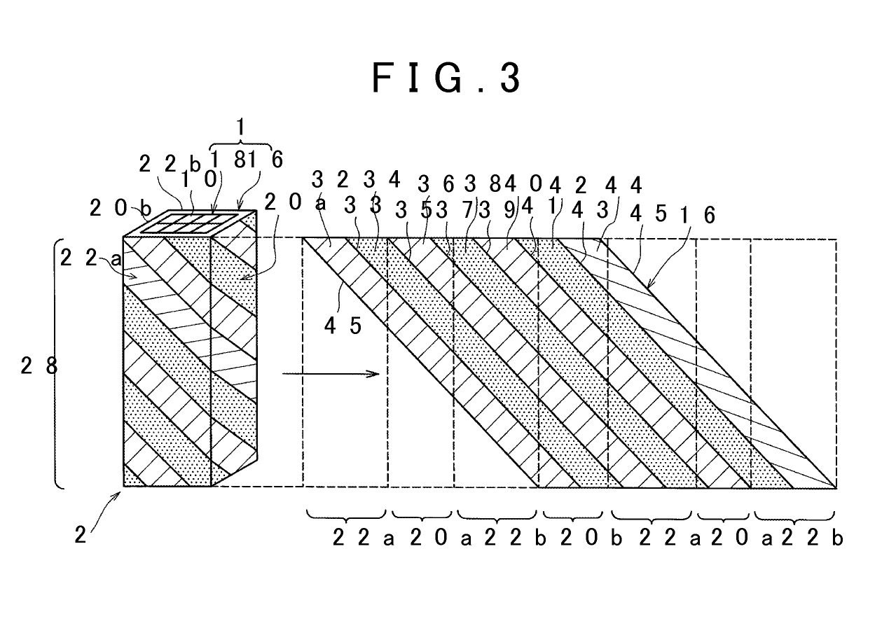

FIG. 3 is a perspective view (left side) showing the slot-surrounded section 28 of the conductor segment 2 and is a plan view (right side) showing the coating member 16 of the slot-surrounded section 28 in a development state. In FIG. 3, two short side surfaces of the slot-surrounded section 28 having a rectangular cross section are denoted by reference symbols 20a, 20b, and two long side surfaces are denoted by symbols 22a, 22b.

As shown in FIG. 3, the coating member 16 provided around the slot-surrounded section 28 of the conductor segment 2 is formed with a plurality of conductive belts that are wound around the element wire assembly 18. Specifically, the description for this embodiment will be made with an example where the coating member 16 is formed with seven belts 32, 34, 36, 38, 40, 42, 44, for example. A plate material, a foil material, or a tape material made of metal such as copper, aluminum, iron, or an alloy thereof can be used for each of the belts 32 to 44. It is particularly preferable to use the member made of copper that has low electric resistance. Further, in this embodiment, each of the belts 32 to 44 has a planar shape of a parallelogram.

The belts 32 to 44 are obliquely wound with respect to the longitudinal direction of the coil wire 1. In an example shown in FIG. 3, the longitudinal direction of the belts form an angle of 45 degrees with respect to the longitudinal direction (the vertical direction on the page) to the coil wire 1. Further, the belts 32 to 44 are wound in parallel via respective insulating sections 33, 35, 37, 39, 41, 43, 45 provided between each other, and the belts 32 to 44 are thereby electrically insulated from each other in the slot-surrounded section 28. Here, the insulating sections 33 to 45 are formed with gaps formed among the belts 32 to 44. However, the insulating sections 33 to 45 may be formed with insulating materials such as connection members made of a resin that are provided in the gaps among the belts 32 to 44.

The belts will more specifically be described with reference to the development view in FIG. 3. The belt 32 among the seven belts 32 to 44 is wound from an upper edge of the long side surface 22a of the slot-surrounded section 28 as a start position, through the long side surface 22a, the short side surface 20a, and the long side surface 22b, to the short side surface 20b in a length that is shorter than one round of the slot-surrounded section 28 in the circumferential direction.

The belt 34 among the seven belts 32 to 44 that adjoins the belt 32 via the insulating section 33 is wound from an upper central position of the long side surface 22a of the slot-surrounded section 28 as a start position, through the long side surface 22a, the short side surface 20a, and the long side surface 22b, and the short side surface 20b, to the long side surface 22a in the length that is shorter than one round of the slot-surrounded section 28 in the circumferential direction.

The other belts 36 to 44 are wound in the length that is shorter than one round of the slot-surrounded section 28 in the circumferential direction in the same way. That is, the belt 36 that adjoins the belt 34 via the insulating section 35 is wound from the short side surface 20a, through the long side surface 22b and the short side surface 20b, to the long side surface 22a. The belt 38 that adjoins the belt 36 via the insulating section 37 is wound from the short side surface 20a, through the long side surface 22b, the short side surface 20b, and the long side surface 22a, to the short side surface 20a. The belt 40 that adjoins the belt 38 via the insulating section 39 is wound from the long side surface 22b, through the short side surface 20b and the long side surface 22a, to the short side surface 20a. The belt 42 that adjoins the belt 40 via the insulating section 41 is wound from the long side surface 22b, through the short side surface 20b, the long side surface 22a, and the short side surface 20a, to the long side surface 22b. The belt 44 that adjoins the belt 42 via the insulating section 43 is wound from the short side surface 20b, through the long side surface 22a and the short side surface 20a, to the long side surface 22b.

In the description above, each of the plurality of belts 32 to 44 that constitute the coating member 16 of the slot-surrounded section 28 is shorter than one round of the coil wire 1 in the circumferential direction; however, the present invention is not limited to this, but the belt may be wound in a length that is longer than one round.

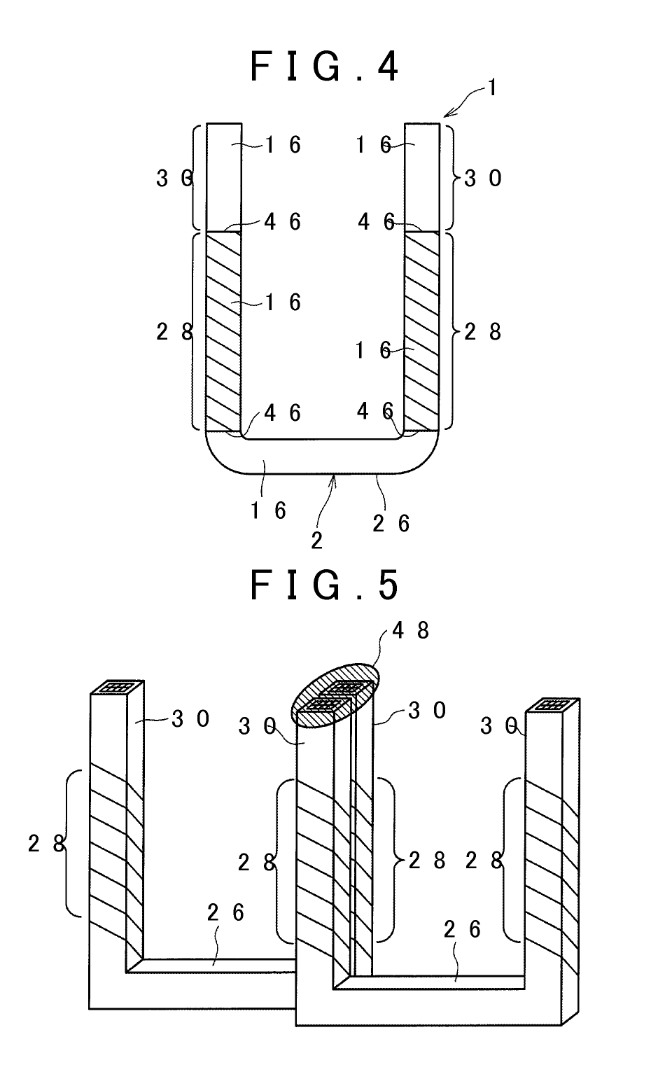

FIG. 4 is a plan view of the conductor segment 2. The two slot-surrounded sections 28 of the coil wire 1 that are formed as described above are prepared, one ends of the slot-surrounded sections 28 are coupled to the connection section 26 at welded sections 46, the distal end sections 30 of the legs 24a, 24b are coupled to the other ends of the slot-surrounded sections 28 at the welded sections 46. At the welded sections 46, the plurality of element wires 10 contained in the coil wire 1 are electrically connected together between the slot-surrounded section 28 and the connection section 26 and between the slot-surrounded sections 28 and the distal end sections 30 of the legs 24a, 24b, and the coating members 16 of the slot-surrounded sections 28 are electrically connected to the coating members 16 of the connection section 26 and the distal end sections 30 of the legs 24a, 24b. The conductor segment 2 is thereby formed.

Here, the coating members 16 of the connection section 26 and the distal end sections 30 of the legs 24a, 24b of the conductor segment 2 may be formed as one conductive member having no helical insulating section, for example. It is because a loss caused by eddy current and circulating current due to a leakage flux is not required to be considered in the coil end section. In this case, a coating member that coats a periphery of the element wire assembly 18 with a pipe material made of metal may be formed. Compression molding may be performed by making the element wire assembly 18 inserted in a cylindrical pipe material pass through a die hole, and the coil wire having a rectangular cross section in FIG. 1 may be formed. Such formation provides an advantage that rigidity of the coil wires constituting the coil end section is enhanced and welding between the conductor segments, positioning of the coil, and the like can stably be performed. However, it is matter of course that the single or plurality of conductive belts may be wound around the connection section 26 and the distal end sections 30 to form the coating members.

After the conductor segment 2 is inserted in the slot 5 of the motor stator 3 and the bending process and so forth are performed as described above, as shown in FIG. 5, the distal end sections 30 of the legs 24a, 24b of the conductor segments 2 are coupled together at a welded section 48. Accordingly, the plurality of conductor segments 2 are electrically connected together, thereby forming the coil wound around the motor stator 3. At the welded section 48, the plurality of element wires 10 contained in the conductor segments 2 are electrically connected together, and the coating members 16 are also electrically connected together.

Before the generally U-shaped conductor segment 2 is fabricated by the bending process, an insulating film is formed with an enamel resin and the like on an outer peripheral surface of the coil wire 1 that is linearly extended.

The motor stator 3 around which the coil formed with the coil wire 1 of this embodiment that has an above-described configuration is wound is installed in a three-phase synchronous motor (rotating electric machine (not shown)), for example, a three-phase alternating voltage is applied to the coil, and a rotating magnetic field is thereby generated on an inner peripheral side of the motor stator 3. Accordingly, a rotor (not shown) which is rotatably provided on the inside of motor stator 3 is driven to rotate by an effect of the rotating magnetic field. A magnetic flux then goes in and out in the radial direction through the tooth 4 of the motor stator 3, and the magnetic flux may leak from the tooth 4 into the slot 5 in the circumferential direction when magnetic saturation occurs in the tooth 4. Such leakage of the magnetic flux is particularly likely to occur in a high-output motor.

The magnetic flux leaking into the slot 5 fluctuates according to the motor output. When such a fluctuating magnetic flux interlinks with the coil wire disposed in the slot 5, eddy current is generated in the conductive coating member that coats a periphery of the coil wire and connected with other eddy current to form circulating current. Flow of the circulating current results in a loss.

In contrast, according to the coil wire 1 of this embodiment, the plurality of belts 32 to 44 that constitutes the coating member 16 are obliquely wound with respect to the longitudinal direction of the coil wire 1. Accordingly, when the fluctuating leakage magnetic flux interlinks with the coating member 16 of the coil wire 1 in the slot-surrounded section 28, flow directions of eddy current are opposite on the short side surface 20a and the short side surface 20b, and the eddy current is canceled out. As a result, generation of eddy current in the belts 32 to 44 can be hindered, and a loss caused by circulating current due to eddy current can be reduced.

Further, according to the coil wire 1 of this embodiment, the plurality of metal belts 32 to 44 that constitute the slot-surrounded section 28 are obliquely wound with respect to the longitudinal direction of the coil wire, and the belts 32 to 44 are insulated from each other via the insulating sections 33 to 45. Accordingly, the coating member 16 is split in such a manner, generation of eddy current and circulating current and the loss due to those can be reduced.

Moreover, according to the coil wire 1 of this embodiment, the plurality of metal belts 32 to 44 that constitute the slot-surrounded section 28 are obliquely wound with respect to the longitudinal direction of the coil wire while they are insulated from each other. Therefore, the electric resistance is reduced for the removed length of current path compared to a case where a single belt plate material made of metal is helically wound around the coil wire to form the coating member. As a result, a resistive loss can be reduced.

Still further, the coating member 16 formed by winding the plurality of metal belts on the outer peripheral surface of the element wire assembly 18 formed by bundling the plurality of element wires 10 is coated on the coil wire 1 in a tightly fitting manner, and the proportion of a conductor section in a cross section can thus be increased. This provides an advantage that a space factor of the coil wire 1 that is formed into the coil and disposed in the slot of the motor stator can be improved and a motor efficiency can be improved.

It should be noted that the coil wire for a rotating electric machine in accordance with the present invention is not limited to the above-described embodiments and modification examples and can variously be changed and improved within the scope of matters recited in the claims of this application and equivalents thereof.

For example, in the description above, the coil wire 1 is formed as the generally U-shaped conductor segment, and the plurality of conductor segments are connected together by welding or the like to constitute the coil. However, the present invention is not limited to this, but the coil may be formed by winding the coil wire around the tooth or a bobbin in a coil shape while the coil wires in which the slot-surrounded sections are formed at prescribed intervals are continuously connected together.

What is claimed is:

1. A coil wire for a rotating electric machine, comprising:
an element wire assembly formed by bundling a plurality of element wires, the plurality of element wires being coated so as to be insulated from each other; and
a coating member having conductivity, the coating member coating a periphery of the element wire assembly, the coating member being positioned in a slot of a stator of the rotating electric machine and obliquely wound with respect to a longitudinal direction of the coil wire, and the coating member being formed with a plurality of conductive belts electrically insulated from each other.

2. The coil wire for a rotating electric machine according to claim 1, wherein the plurality of conductive belts are wound in parallel via an insulating member disposed between each other.

3. The coil wire for a rotating electric machine according to claim 1, wherein the plurality of conductive belts are wound in parallel at an interval from each other.

4. The coil wire for a rotating electric machine according to claim 1, wherein the coil wire is a generally U-shaped conductor segment that has two legs and a connection section connecting one ends of the legs together, the connection section and distal end sections of the legs of the conductor segment constitute coil end sections, and an intermediate section of the leg that is positioned in the slot forms a slot-surrounded section.

5. A coil body for a rotating electric machine, comprising
a coil wire for a rotating electric machine, including:
an element wire assembly formed by bundling a plurality of element wires, the plurality of element wires being coated so as to be insulated from each other; and
a coating member having conductivity, the coating member coating a periphery of the element wire assembly, the coating member being positioned in a slot of a stator of the rotating electric machine and being obliquely wound with respect to a longitudinal direction of the coil wire, and the coating member being formed with a plurality of conductive belts electrically insulated from each other,
wherein the coil wire for the rotating electric machine is formed in a coil shape so as to be wound around a tooth of a stator of the rotating electric machine.
